(19) United States
(12) Patent Application Publication
(10) Pub. No.: US 2016/0121279 A1
(43) Pub. Date: May 5, 2016

(54) DEVICE FOR PRODUCING POLYMER DISPERSION SOLUTION OF CORE-SHELL STRUCTURED SILICON NANOPARTICLES

(71) Applicant: OCI COMPANY LTD., Seoul (KR)

(72) Inventors: Cheon-Bae KIM, Seongnam-si (KR); Yo-Seop KIM, Seongnam-si (KR); Sung-Ho JUNG, Seongnam-si (KR)

(21) Appl. No.: 14/887,265

(22) Filed: Oct. 19, 2015

(30) Foreign Application Priority Data
Oct. 29, 2014 (KR) 10-2014-0148290

(51) Int. Cl. B01F 11/02; B01F 3/12

(52) U.S. Cl. CPC B01F 11/02; B01F 3/1271; B01F 2215/0036

(57) ABSTRACT

Disclosed herein is a device for producing a polymer dispersion solution of core-shell structured silicon nanoparticles. The device includes: a canister for storing silicon nanoparticles; a quantitative feeder for receiving the silicon nanoparticles released from the canister and for quantitatively feeding the same; a mixing tank for mixing block copolymer constituting a shell, and a dispersion solvent, and the silicon nanoparticles fed through the quantitative feeder to form core-shell structured silicon nanoparticles; an ultrasonic disperser for receiving the core-shell structured silicon nanoparticles released from the mixing tank and a dispersion solvent and for dispersing the particles with ultrasonic waves; and a dispersion solvent tank for feeding a dispersion solvent into the mixing tank and the ultrasonic disperser.

### CROSS-REFERENCE TO RELATED APPLICATIONS

This application claims the benefit of Korean Patent Application No. 10-2014-0148290, filed on Oct. 29, 2014, entitled “DEVICE FOR PRODUCING POLYMER DISPERSION SOLUTION OF CORE-SHELL STRUCTURED SILICON NANOPARTICLES”, which is hereby incorporated by reference in its entirety into this application.

### BACKGROUND

1. Technical Field

The present disclosure relates to a device for producing a polymer dispersion solution of silicon nanoparticles having a core-shell structure which can reduce volumetric change.

2. Description of the Related Art

According to the technology development and the increasing demand for mobile devices, a need for secondary batteries as an energy source rapidly increases, and, among such secondary batteries, lithium secondary batteries, which exhibit high energy density and operation potential and have a long cycle life and a low self-discharge rate, are commercialized and widely used in the art.

In addition, as interest in environmental issues grows, many researches on electric vehicles, hybrid electric vehicles, etc., which can replace vehicles using fossil fuels which are one of the main causes of air pollution, such as gasoline vehicles and diesel vehicles, are proceeding; and lithium secondary batteries are in the commercialization stage as a power source for such electric vehicles, hybrid electric vehicles, and the like.

Lithium metal was previously used as an anode active material in the art, but, currently, carbon-based materials are widely used as an anode active material because of the explosion hazard resulted from the cell short circuit occurred by the formation of dendrites in case of using lithium metal.

Examples of the carbon-based active material used as an anode active material for lithium secondary batteries are crystalline carbon, such as natural graphite and artificial graphite, and amorphous carbon, such as soft carbon and hard carbon. However, there is a problem in that, although the amorphous carbon has greater capacity, the irreversibility in the charge and discharge process is high. Graphite is used as a representative crystalline carbon, and utilized as an anode active material owing to its high theoretical limit capacity of 372 mAh/g, but graphite suffers from severe degradation in lifespan.

Moreover, since such graphite and carbon-based active material have a theoretical capacity of 372 mAh/g at most, and, thus, there is a problem in that the above-mentioned anode cannot be used in the development of lithium secondary batteries having high capacity in the future.

To solve the above problems, the material being actively studied in recent years is a metal-based or intermetallic compound-based anode active material. For example, lithium secondary batteries utilizing, as an anode active material, a metal or semi-metal, such as aluminum, germanium, silicon, tin, zinc, lead, etc., are being studied in the art. Since such materials have high capacity and high energy density, and may occlude and release more lithium ions than anode active materials using carbon-based materials, it is believed that a lithium secondary batteries having high capacity and high energy density may be manufactured with such materials. For instance, pure silicon is known to have a high theoretical capacity of 4,017 mAh/g.

However, silicon anodes have difficulties in commercialization due to the degradation of cycle properties compared with the carbon-based materials, since conductivity between active materials deteriorates due to volumetric change during charge and discharge process, or an anode active material is peeled off from an anode current collector, when inorganic particles, such as silicon and tin, are used per se as an anode active material. That is, since the inorganic particles, such as silicon and tin, included in the anode active material occlude lithium during charge, the volume of the inorganic particles expands to about 300% to 400% by volume. Moreover, the inorganic particles contract when lithium is released during discharge. Since lithium secondary batteries can suffer from rapid deterioration in lifespan due to possible electrical insulation caused by an empty space generated between the inorganic particles and the anode active material during repeated charge and discharge cycles, this is a serious problem for use in lithium secondary batteries.

In the related prior art, Korea Patent Publication No. 10-2014-0096581 (published on Aug. 6, 2014) discloses a composite of graphene and core-shell structured silicon nanoparticles, a method for preparing the same, and an electrochemical device comprising the same as an active material.

### SUMMARY

An object of the present disclosure is to provide a device capable of continuously producing a solution in which core-shell structured silicon nanoparticles are dispersed.

In accordance with one aspect of the present disclosure, a device for producing a polymer dispersion solution of core-shell structured silicon nanoparticles includes: a canister for storing silicon nanoparticles; a quantitative feeder for receiving the silicon nanoparticles from the canister and for quantitatively feeding the silicon nanoparticles; a mixing tank for mixing block copolymer constituting a shell, a dispersion solvent, and the silicon nanoparticles fed through the quantitative feeder to form core-shell structured silicon nanoparticles; an ultrasonic disperser for receiving the core-shell structured silicon nanoparticles from the mixing tank and a dispersion solvent and for dispersing the particles with ultrasonic waves; and a dispersion solvent tank for feeding a dispersion solvent into the mixing tank and the ultrasonic disperser.

The device may further include a plasma reactor for forming silicon nanoparticles and for feeding the same into the canister.

The mixing tank may have an internal pressure relatively lower than an internal pressure of the quantitative feeder.

The device may further include between the quantitative feeder and the mixing tank a cushion hopper for preventing a vapor inside the mixing tank from flowing into the quantitative feeder.

The device may further include between the mixing tank and the ultrasonic disperser a pre-filter for filtering out large particles and particle agglomerates, and may further include at an outlet side of the ultrasonic disperser an end-filter for filtering out non-dispersed particle agglomerates.

The quantitative feeder may have a sealed enclosure, and an inside the sealed enclosure may be filled with an inert gas to prevent the silicon nanoparticles from contacting with air.

The device may further include a circulation pipe for circulating the polymer dispersion solution of core-shell structured silicon nanoparticles, released from the ultrasonic disperser, into the mixing tank.

The block copolymer may be for forming a block copolymer shell comprising blocks having a high affinity for Si and blocks having a low affinity for Si, in which the blocks having a high affinity for Si may be polyacrylic acid, polyacrylate, polymethacrylic acid, polymethyl methacrylate, polyacrylamide, carboxymethyl cellulose, polyvinyl acetate, or polymaleic acid, and the blocks having a low affinity for Si may be polystyrene, polyacrylonitrile, polyphenol, polyethylene glycol, polylauryl methacrylate, or polyvinyl difluoride.

The dispersion solvent may be at least one selected from the group consisting of N-methyl-2-pyrrolidone (NMP), tetrahydrofuran (THF), water, methanol, ethanol, cyclohexanol, cyclohexanone, methyl ethyl ketone, acetone, dimethylsulfoxide (DMSO), and a combination thereof.

### BRIEF DESCRIPTION OF THE DRAWINGS

FIG. 1 is a diagram illustrating a device for producing a polymer dispersion solution of core-shell structured silicon nanoparticles according to a first embodiment of the present disclosure;

FIG. 2 is a diagram illustrating a device for producing a polymer dispersion solution of core-shell structured silicon nanoparticles according to a second embodiment of the present disclosure;

FIG. 3 is a histogram showing the overall diameter of Si-block copolymer core-shell nanoparticles with respect to the weight ratio of Si core to block copolymer shell, as measured by dynamic light scattering;

FIG. 4 is an image of (a) Si-block copolymer core-shell nanoparticles, and (b) Si nanoparticles, as observed by energy dispersive X-ray spectroscopy;

FIG. 5 is an image of (a) Si-block copolymer core-shell nanoparticles, and (b) Si nanoparticles, as observed by scanning electron microscope;

FIG. 6 is an image of (a) Si-block copolymer core-shell nanoparticles, and (b) Si nanoparticles, as observed by transmission electron microscope;

FIG. 7 is a graph showing the dispersibility of (a) Si-block copolymer core-shell nanoparticles in a mixed solution comprising the Si-block copolymer core-shell nanoparticles, and (b) Si nanoparticles in a mixed solution comprising the Si nanoparticles, as confirmed by dynamic light scattering;

FIG. 8 is a view showing the visual observation results and the dispersion heights with respect to the concentrations of (a) Si cores in a mixed solution comprising Si-block copolymer core-shell nanoparticles, and (b) Si nanoparticles in a mixed solution comprising the Si nanoparticles; and

FIG. 9 is a view showing the visual observation results and the particle size distributions of Si-block copolymer core-shell nanoparticles (“P4” to “P9”) in a mixed solution comprising the Si-block copolymer core-shell nanoparticles, Si nanoparticles (“C”) in a mixed solution comprising the Si nanoparticles, and Si-polystyrene mixture (“STY”) in a mixed solution comprising the Si-polystyrene mixture.

### DETAILED DESCRIPTION

Prior to description, it should be noted that the terms or words used in the specification and claims should not be construed as having common and dictionary meanings, but should be interpreted as having meanings and concepts corresponding to the technical spirit of the present disclosure based on the principle that the inventor can properly define the concepts of the terms in order to describe his/her invention in the best way. Thus, the embodiments described in the specification and the configurations shown in the drawings are simply the most preferable examples of the present disclosure and are not intended to illustrate all aspects of the spirit of the present disclosure. Accordingly, it should be understood that various equivalents and modifications that may replace these embodiments are possible at the time of filing of the present application.

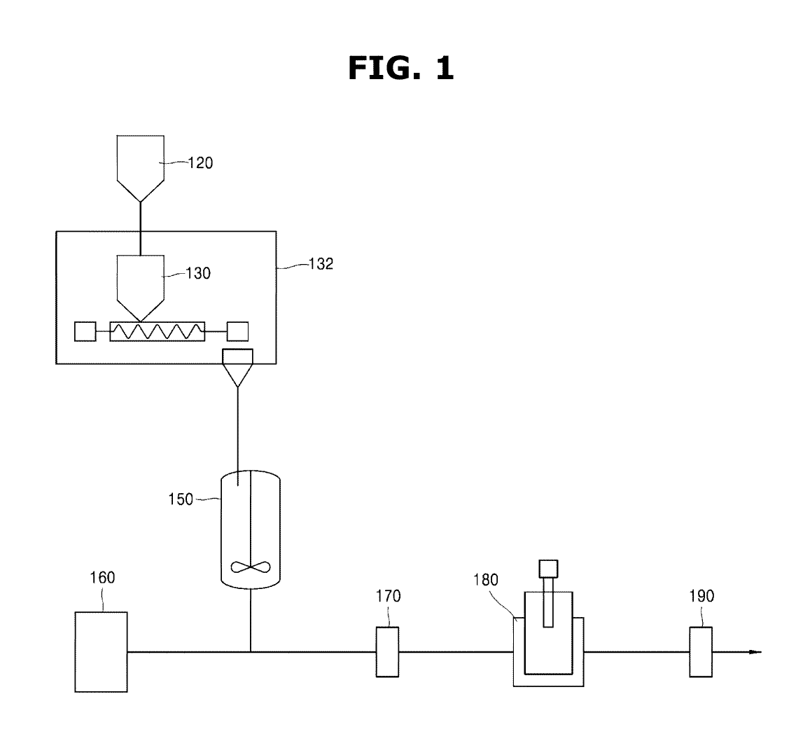

FIG. 1 illustrates a device for producing a polymer dispersion solution of core-shell structured silicon nanoparticles according to the first embodiment of the present disclosure.

As shown in FIG. 1, the device for producing a polymer dispersion solution of core-shell structured silicon nanoparticles according to the first embodiment of the present disclosure includes: a canister 120 for storing silicon nanoparticles; a quantitative feeder 130 for receiving the silicon nanoparticles released from the canister 120 and for quantitatively feeding the same; a mixing tank 150 for mixing block copolymer constituting a shell, a dispersion solvent, and the silicon nanoparticles fed through the quantitative feeder 130 to form core-shell structured silicon nanoparticles; an ultrasonic disperser 180 for receiving the core-shell structured silicon nanoparticles released from the mixing tank and a dispersion solvent and for dispersing the particles with ultrasonic waves; and a dispersion solvent tank 160 for feeding a dispersion solvent into the mixing tank 150 and the ultrasonic disperser 180.

In the canister 120, silicon nanoparticles are stored, but the silicon nanoparticles are rapidly oxidized upon contacting with air. Accordingly, an inside the canister 120 is preferably purged with an inert gas such as nitrogen gas, and subsequently sealed. The canister 120 stores the silicon nanoparticles and intermittently feeds the same to the below-mentioned qauntitative feeder.

The quantitative feeder 130 is for quantitatively feeding the silicon nanoparticles into the mixing tank 150. To precisely meter the input of the silicon nanoparticles, loss-in-weight feeder may be applied.

Further, it is preferable that, in order to prevent the oxidation of silicon nanoparticles, the quantitative feeder may be equipped with a sealed enclosure 132, and an inside the sealed enclosure may be purged with an inert gas such as nitrogen gas.

The mixing tank 150 is for mixing block copolymer polymers, a dispersion solvent, and the silicon nanoparticles to form core-shell structured silicon nanoparticles, and a stirrer is equipped inside the mixing tank. Moreover, to prevent the oxidation of silicon nanoparticles, it is preferred to allow an inert gas such as nitrogen gas to be introduced thereto.

On the other hand, in order to prevent a vapor of the dispersion solvent stored in the mixing tank 150 from flowing into the above-mentioned quantitative feeder 130 through a supply pipe for silicon nanoparticles, it is preferred to set an internal pressure of the mixing tank 150 lower than an internal pressure of the quantitative feeder 130. This is because, if the vapor of the dispersion solvent is introduced into the quantitative feeder 130, the silicon nanoparticles may be adsorbed inside the quantitative feeder.

The ultrasonic disperser 180 is a device for dispersing the core-shell structured silicon nanoparticles in a dispersion solvent, and may be provided with a cooling jacket on the outside thereof in order to remove heat generated during dispersion.

Meanwhile, a dispersion solvent tank 160 for feeding a dispersion solvent into the ultrasonic disperser 180 may be included.

Further, the device for producing a polymer dispersion solution of core-shell structured silicon nanoparticles according to the present disclosure may further include a pre-filter 170 between the mixing tank 150 and the ultrasonic disperser 180. The pre-filter 170 serves to filter out large particles, which may be contained in the silicon nanoparticle powder, or particle agglomerates, which may be formed at the time of mixing in the mixing tank. Metal mesh filters may be used as the pre-filter 170.

In addition, an end-filter 190 for filtering out non-dispersed particle agglomerates may be further included at the outlet side of the ultrasonic disperser 180.

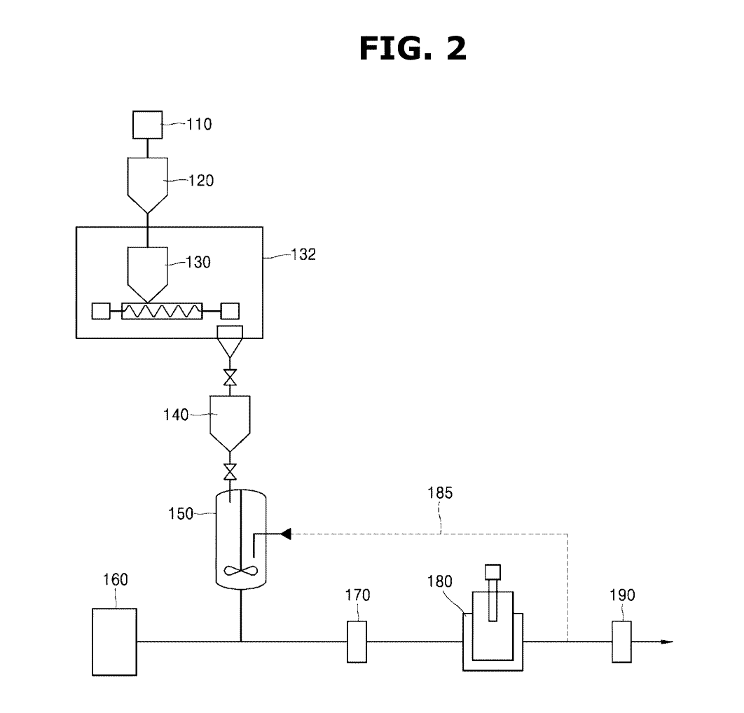

FIG. 2 illustrates a device for producing a polymer dispersion solution of core-shell structured silicon nanoparticles according to the second embodiment of the present disclosure.

The second embodiment includes all the elements of the first embodiment, and is characterized by further comprising a plasma reactor 110 for forming silicon nanoparticles and for feeding the same into the canister, and a cushion hopper 140 between the quantitative feeder 130 and the mixing tank 150 for preventing a dispersion solvent vapor from flowing into the quantitative feeder 130.

The cushion hopper 140 equipped with a pair of valves at the inlet side and outlet side thereof, which are opened and closed in turn, serves to prevent the vapor of the dispersion solvent stored in the mixing tank 150 from flowing into the quantitative feeder 130.

Moreover, the second embodiment further includes a circulation pipe 185 for circulating the dispersion solution, released from the ultrasonic disperser 180, into the mixing tank 150. By circulating the dispersion solution, released from the ultrasonic disperser 180, into the mixing tank 150, the stirring and dispersing repeated several times ensure the quality of the dispersion solution.

The present disclosure relates to a device for producing a dispersion solution by using a Si-block copolymer core-shell silicon nanoparticles comprising a Si core; and a block copolymer shell comprising blocks having a high affinity for Si and blocks having a low affinity for Si, in which the block copolymer shell surrounds the Si core to form a spherical micelle structure.

The core-shell nanoparticles have a structure where a Si core is present in the center thereof and a block copolymer shell consisting of blocks having a high affinity for Si and blocks having a low affinity for Si is coated onto the surface of the Si core. The block copolymer shell of the core-shell nanoparticles forms a spherical micelle structure, in which the blocks having a high affinity for Si associate, pointing inside towards the surface of the Si core, and the blocks having a low affinity for Si associate, pointing outside away from the Si core, by van der Waals force and the like.

In this way, the block copolymer shell of the core-shell nanoparticles forms a spherical micelle structure around the Si core; and, since the core-shell nanoparticles exhibit excellent dispersibility and stability in a mixed solution comprising the core-shell nanoparticles, the core-shell nanoparticles reduce agglomeration of particles, and, thus, have a smaller particle size than that of simple nanoparticles

A weight ratio of the Si core to the block copolymer shell is preferably 2:1 to 1000:1, and the weight ratio of the Si core to the block copolymer shell is more preferably 4:1 to 20:1, without being limited thereto. Here, if the weight ratio of the Si core to the block copolymer shell is less than 2:1, the content of the Si core capable of being actually alloyed with lithium decreases in an anode active material, thereby causing a problem in that capacity of the anode active material and efficiency of lithium secondary batteries are lowered. Conversely, if the weight ratio of the Si core to the block copolymer shell is greater than 1000:1, the content of the block copolymer shell decreases, and dispersibility and stability deteriorate in a mixed solution comprising the core-shell nanoparticles, thereby causing a problem in that the block copolymer shell of carbonized core-shell nanoparticles cannot properly perform buffering action.

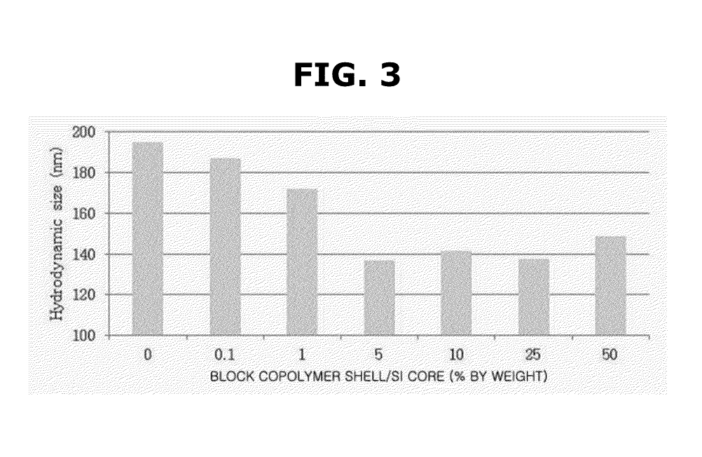

FIG. 3 shows the overall diameter of Si-block copolymer core-shell nanoparticles depending on the weight ratio of Si core to block copolymer shell, as measured by dynamic light scattering.

As shown in FIG. 3, if the weight ratio of the Si core to the block copolymer shell in the Si-block copolymer core-shell nanoparticles ranges from 2:1 (the block copolymer shell/Si core is 50% by weight) to 1000:1 (the block copolymer shell/Si core is 0.1% by weight), particularly, if the weight ratio of the Si core to the block copolymer shell in the Si-block copolymer core-shell nanoparticles ranges from 4:1 (the block copolymer shell/Si core is 25% by weight) to 20:1 (the block copolymer shell/Si core is 5% by weight), the Si-block copolymer core-shell nanoparticles have a greatly reduced overall diameter (hydrodynamic size), as compared with Si nanoparticles (the block copolymer shell/Si core is 0% by weight), and, thus, exhibit excellent dispersibility and stability.

That is, the block copolymer shell of carbonized core-shell nanoparticles is a material for buffering volumetric change due to Si during charge and discharge of lithium secondary batteries rather than a material being actually alloyed with lithium in an anode active material, and it is preferred to be included in a small quantity as compared with the Si core.

In addition, the Si core may be a spherical shape having a diameter from 2 nm to 200 nm, and the block copolymer shell may have a thickness from 1 nm to 50 nm.

A ratio of the diameter of the Si core to the thickness of the block copolymer shell preferably ranges from 1:25 to 200:1, without being limited thereto. When the ratio of the diameter of the Si core to the thickness of the block copolymer shell is maintained between 1:25 to 200:1, the Si-block copolymer core-shell nanoparticles are particularly suitable for application to a Si/amorphous carbon/crystalline carbon composite having a cabbage structure aimed at dimensional stability of an electrode in response to volumetric expansion of Si.

Thus, the Si-block copolymer core-shell nanoparticles have a structure in which the Si core is present in the center thereof and the block copolymer shell is coated onto the surface of the Si core, and may have an overall diameter from 4 nm to 300 nm.

The blocks having a relatively high affinity for Si associate, pointing inside towards the surface of the Si core, by van der Waals force and the like. Here, the blocks having a relatively high affinity for Si are preferably polyacrylic acid, polyacrylate, polymethacrylic acid, polymethyl methacrylate, polyacryl amide, carboxymethyl cellulose, polyvinyl acetate, or polymaleic acid, without being limited thereto.

The blocks having a relatively low affinity for Si associate, pointing outside away from the Si core, by van der Waals force and the like. Here, the blocks having a relatively low affinity for Si are preferably polystyrene, polyacrylonitrile, polyphenol, polyethylene glycol, polylauryl methacrylate, or polyvinyl difluoride, without being limited thereto.

The block copolymer shell is most preferably a polyacrylic acid-polystyrene block copolymer shell. Here, a number average molecular weight (Mₙ) of the polyacrylic acid is preferably from 100 g/mol to 100,000 g/mol, and a number average molecular weight (Mₙ) of the polystyrene is preferably from 100 g/mol to 100,000 g/mol, without being limited thereto.

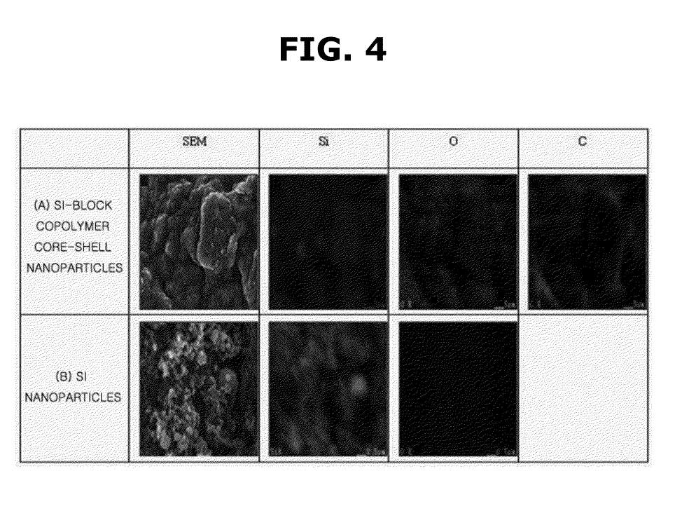

FIG. 4 shows (a) Si-block copolymer core-shell nanoparticles, and (b) Si nanoparticles, as observed by energy dispersive X-ray spectroscopy.

As shown in FIG. 4, from the distribution of Si, C, and O, it can be seen that the (a) Si-block copolymer core-shell nanoparticles have a C and O-containing polymer shell formed on the surface of the Si core, contrary to the (b) Si nanoparticles.

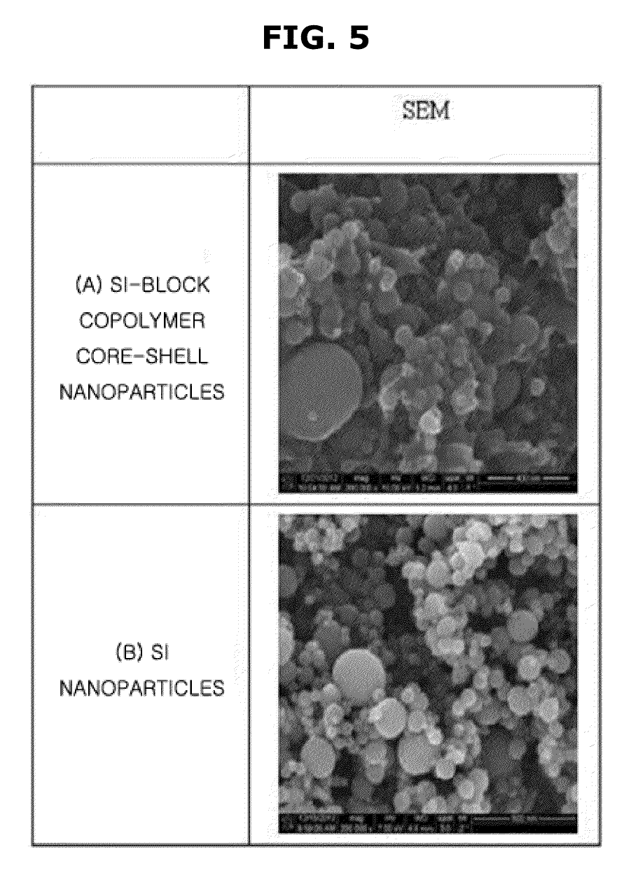

FIG. 5 shows (a) Si-block copolymer core-shell nanoparticles, and (b) Si nanoparticles, as observed by scanning electron microscope.

As shown in FIG. 5, it can be seen that the (a) Si-block copolymer core-shell nanoparticles have a polymer shell formed on the surface of the Si core, unlike the (b) Si nanoparticles.

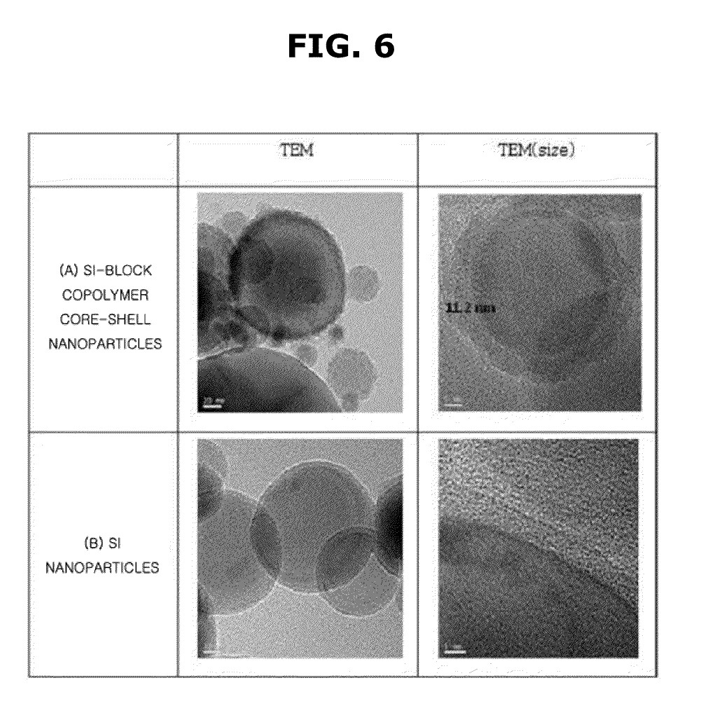

FIG. 6 shows (a) Si-block copolymer core-shell nanoparticles, and (b) Si nanoparticles, as observed by transmission electron microscope.

As shown in FIG. 6, it can be seen that the (a) Si-block copolymer core-shell nanoparticles have a polymer shell formed on the surface of the Si core, contrary to the (b) Si nanoparticles, and that the polymer shell formed on the surface of the Si core has a thickness of 11.2 nm.

In the present disclosure, the dispersion solvent is preferably at least one selected from the group consisting of N-methyl-2-pyrrolidone (NMP), tetrahydrofuran (THF), water, methanol, ethanol, cyclohexanol, cyclohexanone, methyl ethyl ketone, acetone, dimethyl sulfoxide (DMSO), and a combination thereof, without being limited thereto. Here, if N-methyl-2-pyrrolidone (NMP) solvent or tetrahydrofuran (THF) solvent is used, the core-shell nanoparticles according to the present disclosure have excellent dispersibility and stability in the mixed solution comprising the core-shell nanoparticles, without phase separation.

The block copolymer include a block having a high affinity for Si and a block having a low affinity for Si.

The block having a high affinity for Si is preferably polyacrylic acid, polyacrylate, polymethyl methacrylic acid, polymethyl methacrylate, polyacrylamide, carboxymethyl cellulose, polyvinyl acetate, or polymaleic acid, without being limited thereto.

The block having a low affinity for Si is preferably polystyrene, polyacrylonitrile, polyphenol, polyethylene glycol, polylauryl acrylate, or polyvinyl difluoride, without being limited thereto.

The block copolymers are most preferably a polyacrylic acid-polystyrene block copolymer. Here, a number average molecular weight (Mr) of the polyacrylic acid is preferably from 100 g/mol to 100,000 g/mol, and a number average molecular weight (Mr) of the polystyrene is preferably from 100 g/mol to 100,000 g/mol, without being limited thereto.

A weight ratio of the Si particles and the block copolymers to be mixed in the mixing tank 150 is preferably from 2:1 to 1000:1, and the weight ratio of the Si particles and the block copolymers is more preferably from 4:1 to 20:1, without being limited thereto.

That is, the block copolymer shell is a material for buffering action, not a material being actually alloyed with lithium in an anode active material, and it is preferred to be contained in an amount smaller than the Si particles.

The mixed solution to which the Si particles is added may be subjected to ultrasonic treatment in the ultrasonic disperser 180, thereby preparing a mixed solution in which the core-shell nanoparticles are dispersed, rather than a simple mixed solution of Si particles and block copolymers. Here, ultrasonic treatment is performed for 5 minutes to 120 minutes at 10 kHz to 100 kHz, thereby minimizing energy loss through short duration ultrasonic treatment.

The block copolymers of the core-shell nanoparticles form a spherical micelle structure around the Si core in the mixed solution comprising the core-shell nanoparticles. Since the core-shell nanoparticles in the mixed solution comprising the core-shell nanoparticles exhibit excellent dispersibility and stability, as compared with Si particles in a mixed solution containing the Si particles or a Si-polystyrene mixture in a mixed solution containing the Si-polystyrene mixture, the core-shell nanoparticles exhibit reduced agglomeration, thereby exhibit a smaller particle size.

Here, the Si-block copolymer core-shell nanoparticles preferably have a particle size distribution from 4 nm to 300 nm in the mixed solution comprising the core-shell nanoparticles, and the Si-block copolymer core-shell nanoparticles more preferably have a particle size distribution from 100 nm to 150 nm in the mixed solution comprising the core-shell nanoparticles, without being limited thereto.

In addition, the Si cores may have a concentration with a wide range of 1% to 50% by weight in the mixed solution comprising the core-shell nanoparticles.

Thus, with excellent dispersibility and stability in the mixed solution comprising the core-shell nanoparticles, the core-shell nanoparticles can be easily applied to an anode active material through carbonization.

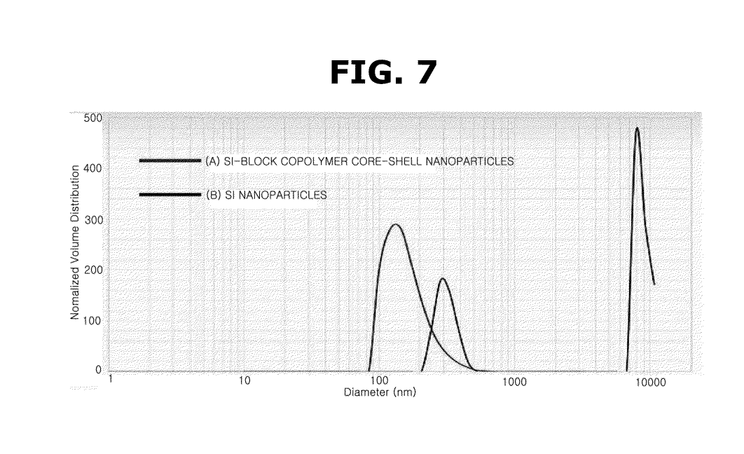

FIG. 7 shows the dispersibility of (a) Si-block copolymer core-shell nanoparticles in a mixed solution comprising the Si-block copolymer core-shell nanoparticles, and (b) Si nanoparticles in a mixed solution comprising the Si nanoparticles, as confirmed by dynamic light scattering.

As shown in FIG. 7, when tetrahydrofuran (THF) solvent is used, it can be seen that the (a) Si-block copolymer core-shell nanoparticles in the mixed solution comprising the Si-block copolymer core-shell nanoparticles have a significantly smaller particle size than that of the (b) Si nanoparticles in the mixed solution comprising the Si nanoparticles.

This is because the block copolymer shell of the core-shell nanoparticles forms a spherical micelle structure around the Si core and the core-shell nanoparticles exhibit excellent dispersibility and stability in the mixed solution comprising the core-shell nanoparticles, thereby exhibit reduced agglomeration and a particle size smaller than that of simple nanoparticles.

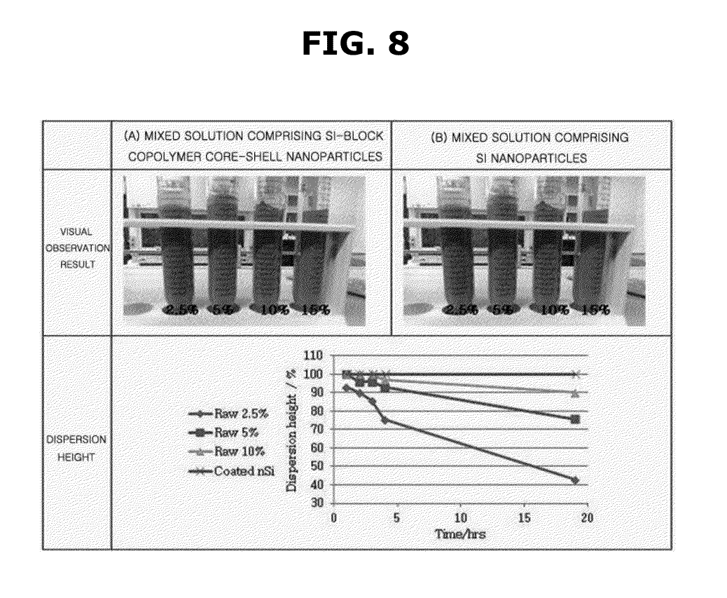

FIG. 8 shows the visual observation results and the dispersion heights depending on the concentrations of (a) Si cores in a mixed solution comprising Si-block copolymer core-shell nanoparticles, and (b) Si nanoparticles in a mixed solution comprising the Si nanoparticles.

As shown in FIG. 8, in case tetrahydrofuran (THF) solvent is used, it can be seen that, although the dispersion height of the Si nanoparticles increases with the increasing concentration of the Si nanoparticles when the (b) Si nanoparticles in the mixed solution comprising the Si nanoparticles have the concentrations of 2.5%, 5% and 10% by weight, the dispersion height of the Si nanoparticles is much lower than that of the Si cores when the (a) Si cores in the mixed solution comprising the Si-block copolymer core-shell nanoparticles have the concentrations of 2.5%, 5% and 10% by weight. In particular, when the (b) Si nanoparticles in the mixed solution comprising the Si nanoparticles have the concentration of 15% by weight, the dispersion height of the Si nanoparticles cannot be measured since the nanoparticles are adhered inside a test tube and dried. However, it can be seen that, even when the (a) Si cores in the mixed solution comprising the Si-block copolymer core-shell nanoparticles have the concentration of 15% by weight, the Si cores keep the high dispersion height without phase separation.

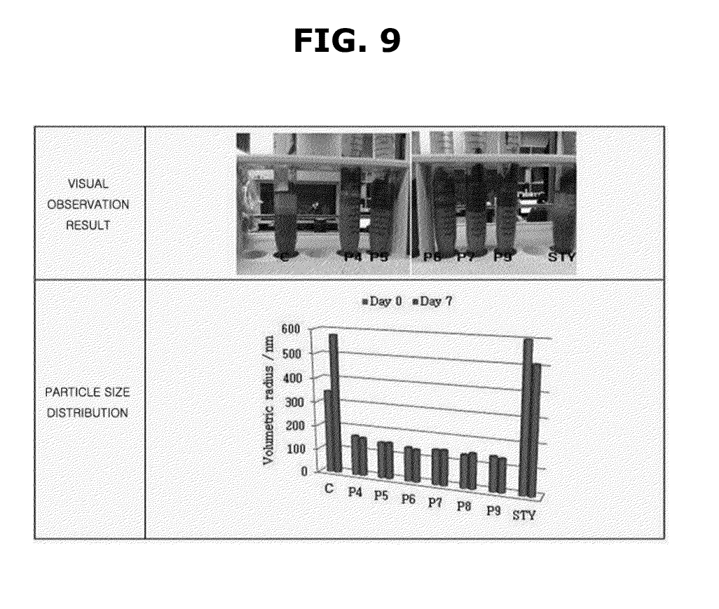

FIG. 9 shows the visual observation results and the particle size distributions of Si-block copolymer core-shell nanoparticles (“P4” to “P9”) in a mixed solution comprising Si-block copolymer core-shell nanoparticles, Si nanoparticles (“C”) in a mixed solution comprising the Si nanoparticles, and Si-polystyrene mixture (“STY”) in a mixed solution comprising the Si-polystyrene mixture.

As shown in FIG. 9, if tetrahydrofuran (THF) solvent is used, based on the particle size distribution of the Si nanoparticles (“C”) of about 350 nm in the mixed solution comprising the Si nanoparticles, the particle size distribution of the Si-polystyrene mixture (“STY”) rather increases in the mixed solution comprising the Si-polystyrene mixture, whereas the particle size distribution of the Si-block copolymer core-shell nanoparticles (“P4” to “P9”) ranges from 135 nm to 150 nm in the mixed solution comprising the Si-block copolymer core-shell nanoparticles. Thus, this demonstrates that the Si-block copolymer core-shell nanoparticles exhibit excellent dispersibility and stability without phase separation.

According to the present disclosure, there is provided a solution in which Si-block copolymer core-shell silicon nanoparticles are dispersed, in which a Si core; and a block copolymer shell comprising blocks having a high affinity for Si and blocks having a low affinity for Si and forming a spherical micelle structure around the Si core, which may be easily applied to an anode active material for lithium secondary batteries. Therefore, the present disclosure provides lithium secondary batteries having long lifespan, high capacity and high energy density, by applying the anode active material comprising carbonized Si-block copolymer core-shell nanoparticles and pores. In addition, the block copolymer shell of the carbonized Si-block copolymer core-shell nanoparticles produces the effect of improving lifespan property by alleviating volumetric change during charge and discharge of lithium secondary batteries.

It should be appreciated that the above-described embodiments are illustrative in all aspects but are not limiting. The scope of the present disclosure is defined only by the appended claims rather than the above-mentioned detailed descriptions. In addition, all modifications or alterations deduced from the spirit and the scope of the claims and equivalents thereof are to be construed as falling within the scope of the present disclosure.

What is claimed is:

1. A device for producing a polymer dispersion solution of core-shell structured silicon nanoparticles, comprising:
a canister for storing silicon nanoparticles;
a quantitative feeder for receiving the silicon nanoparticles released from the canister and for quantitatively feeding the silicon nanoparticles;
a mixing tank for mixing block copolymer constituting a shell, a dispersion solvent, and the silicon nanoparticles fed through the quantitative feeder to form core-shell structured silicon nanoparticles;
an ultrasonic disperser for receiving the core-shell structured silicon nanoparticles released from the mixing tank and a dispersion solvent and for dispersing the core-shell structured silicon nanoparticles with ultrasonic waves; and
a dispersion solvent tank for feeding the dispersion solvent into the mixing tank and the ultrasonic disperser.

2. The device according to claim 1, further comprising a plasma reactor for synthesizing silicon nanoparticles and for feeding the silicon nanoparticles into the canister.

3. The device according to claim 1, wherein the mixing tank has an internal pressure relatively lower than an internal pressure of the quantitative feeder.

4. The device according to claim 1, further comprising a cushion hopper for preventing a vapor inside the mixing tank from flowing into the quantitative feeder between the quantitative feeder and the mixing tank.

5. The device according to claim 1, further comprising between the mixing tank and the ultrasonic disperser a pre-filter for filtering out large particles and particle agglomerates.

6. The device according to claim 1, further comprising at an outlet side of the ultrasonic disperser an end-filter for filtering out non-dispersed particle agglomerates.

7. The device according to claim 1, wherein the quantitative feeder has a sealed enclosure, and
an inside of the sealed enclosure is filled with an inert gas to prevent the silicon nanoparticles from contacting with air.

8. The device according to claim 1, further comprising a circulation pipe for circulating the polymer dispersion solution of core-shell structured silicon nanoparticles, released from the ultrasonic disperser, into the mixing tank.

9. The device according to claim 1, wherein the block copolymer are for forming a block copolymer shell comprising blocks having a high affinity for Si and blocks having a low affinity for Si,
wherein the blocks having a high affinity for Si are polyacrylic acid, polyacrylate, polymethacrylic acid, polymethyl methacrylate, polyacrylamide, carboxymethyl cellulose, polyvinyl acetate, or polymaleic acid, and
the blocks having a low affinity for Si are polystyrene, polyacrylonitrile, polyphenol, polyethylene glycol, polylauryl methacrylate, or polyvinyl difluoride.

10. The device according to claim 1, wherein the dispersion solvent is at least one selected from the group consisting of N-methyl-2-pyrrolidone (NMP), tetrahydrofuran (THF), water, methanol, ethanol, cyclohexanol, cyclohexanone, methyl ethyl ketone, acetone, dimethylsulfoxide (DMSO), and a combination thereof.
